(19) United States
(12) Patent Application Publication
(10) Pub. No.: US 2005/0177788 A1
(43) Pub. Date: Aug. 11, 2005

(54) Text to XML transformer and method

(76) Inventor: John Snyder, Waltham, MA (US)

Correspondence Address: LAW OFFICE OF DALE B. HALLING, 24 s. WEBER ST., SUITE 311, COLORADO SPRINGS, CO, 80903, US

(21) Appl. No.: 10/776,400

(22) Filed: Feb. 11, 2004

(51) Int. Cl. G06F 15/00

(52) U.S. Cl. 715/523

(57) ABSTRACT

A text to XML transformer has a transformer program having a number of executable statements. A processor executes the transformer program and converts the input text document into an XML document. The XML document may not contain every element that was in the input text.

### FIELD OF THE INVENTION

The present invention relates generally to the field of computer systems and more particularly to the field of text to XML (extensible Markup Language) transformers and methods.

### BACKGROUND OF THE INVENTION

XML (extensible Markup Language) has quickly become the standard for transferring business data between suppliers and customers and even within a company. XML is a subset of SGML (Standard Generalized Markup Language). Many legacy systems have outputs or require inputs that are text either structured text or semi-structured text. In order for these legacy system to share information with new XML based information systems it is necessary to convert the text output to XML. The traditional way companies solve this problem is to have their IT (Information Technology) group write a specific program to handle each situation. This means that the company now has to support these individualized programs for years to come. If the software programmer leaves the company, it can be difficult to discern why the program is no longer working. In addition, this solution is expensive and slow.

Thus there exists a need for a system that is capable of converting text to XML, that provides a general format that is easy to use, allows the programmer to inexpensively develop a transformer and can quickly generate the required transformer.

### SUMMARY OF INVENTION

A text to XML transformer that overcomes these and other problems has a transformer program having a number of executable statements. A processor executes the transformer program and converts the input text document into an XML document. The XML document does not contain every element that was in the input text. In one embodiment, the text document is a structured text document. In another embodiment, the text document is a semi-structured text document. In another embodiment, the input text document has at least two formats.

In one embodiment, the text to XML commands include a field separator command that defines a field separator in the text document. In one aspect of the invention, the field separator is a comma. In another aspect of the invention, the field separator is a regular expression. The text to XML commands may include a match command that requires a field in the input text document to match a character string or a record is skipped. In one embodiment, the text to XML commands include a tree hierarchy command.

In one embodiment, the input text document is a streaming text. In another embodiment, the XML document is a streaming XML.

In another embodiment, a wizard has a number of queries that are used to defined the transformer program.

In one embodiment, the input text document is from a legacy system and an output is to an XML system.

In one embodiment, the process for converting text to XML includes the steps of defining a transformer program having a number of executable statements. One of the executable statements contains a command that matches a regular expression and takes an action. A text stream is received by the transformer program. The transformer program is executed to convert the text stream into an XML stream. In one embodiment, a text to XML wizard is selected. In one embodiment a field separator command is selected that defines a field separator in the text stream. The field separator may be defined as a regular expression. In one embodiment, the text stream has two or more formats.

In one embodiment, a text to XML transformer includes a wizard that creates a transformer document. The transformer document has a number of statements formed by a text to XML computer language. A processor executes the transformer document and converts the input text document into an XML document. In one embodiment, the text to XML computer language includes a section command to define a section. In another embodiment, the section command uses a regular expression match to define the section.

### BRIEF DESCRIPTION OF THE DRAWINGS

FIG. 1 is a block diagram of a text to XML transformer in accordance with one embodiment of the invention;

FIG. 2 is a block diagram of a text to XML transformer in accordance with one embodiment of the invention;

FIG. 3 is an example of a text file in accordance with one embodiment of the invention;

FIG. 4 is an example of an XML file created by transforming the text file of FIG. 3 in accordance with one embodiment of the invention;

FIG. 5 is an example of a transformer program for the text file of FIG. 3 in accordance with one embodiment of the invention;

FIG. 6 is an example of a text file in accordance with one embodiment of the invention;

FIG. 7 is an example of an XML file created by transforming the text file of FIG. 6 in accordance with one embodiment of the invention; and

FIG. 8 is an example of a transformer program for the text file of FIG. 6 in accordance with one embodiment of the invention;

### DETAILED DESCRIPTION OF THE DRAWINGS

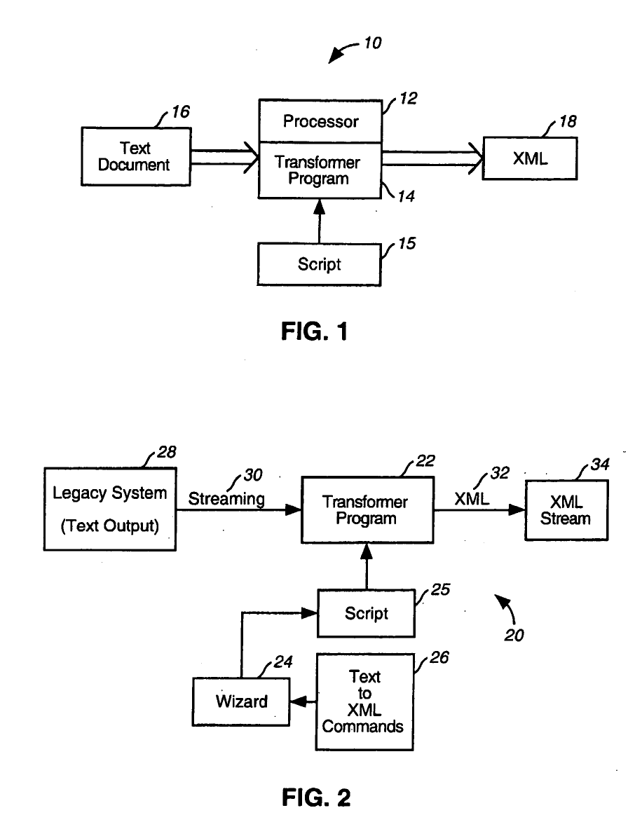

FIG. 1 is a block diagram of a text to XML transformer 10 in accordance with one embodiment of the invention. The XML transformer 10 has a processor 12 that executes a transformer program 14 that has a plurality of executable statements or script 15. The transformer program 14 converts a text document 16 or text stream into an XML file 18 or XML stream. The XML file 18 may contain less than all the elements in the text file 16. This is accomplished by a match command in the executable statements. The script 15 is written in a highly flexible text to XML language that contains a number of different commands. One of these commands allows the program to only output records that match a desired characteristic. For instance, the match command might be used to only output records in a certain date range.

The text file 16 may contain structured or semi-structured text or fixed format messages. An example of structured text is a comma delimited file. An example of semi-structured text is a windows initialization file used by computers. In one embodiment, the text file may contain multiple different formats. For instance, it might have a part that is comma delimited and another part that is delimited by square brackets. The text to XML language is capable of using regular expressions to define a field or element separator. Regular expression definitions can also be used to define a field or element separators for fixed format messages.

FIG. 2 is a block diagram of text to XML transformer 20 in accordance with one embodiment of the invention. The text to XML transformer 20 includes a transformer program 22, a wizard 24 for creating a script 25 to be executed by the transformer document 22 and a plurality of text to XML commands 26 used to create the script 25. The wizard 24 is a menu driven GUI (Graphical User Interface) that guides a user through the process of developing the script 25. The wizard 24 queries a user for input and output destinations, hierarchical structure, how to determine field separators, what actions to take if a particular element matches an element of interest, etc. The text to XML commands form a new computer language that simplifies the process of converting text to XML. Some of the commands will be discussed in more detail with respect to the other figures. The typical system that requires a text to XML transformer is a legacy system 28 that has a text output. That output may be streamed 30 to the transformer 22. The output 32 of the transformer 22 may be streamed XML 34 or an XML system. The XML system 34 is a newer system that provides more flexibility and functionality than the legacy system 28.

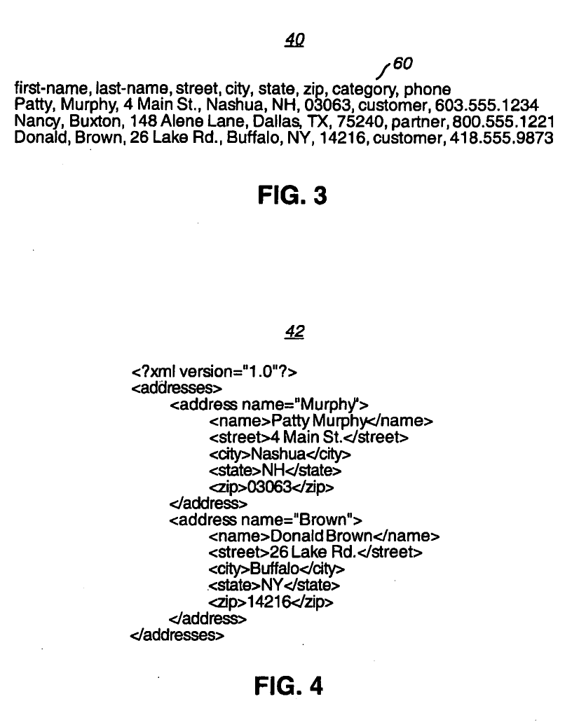

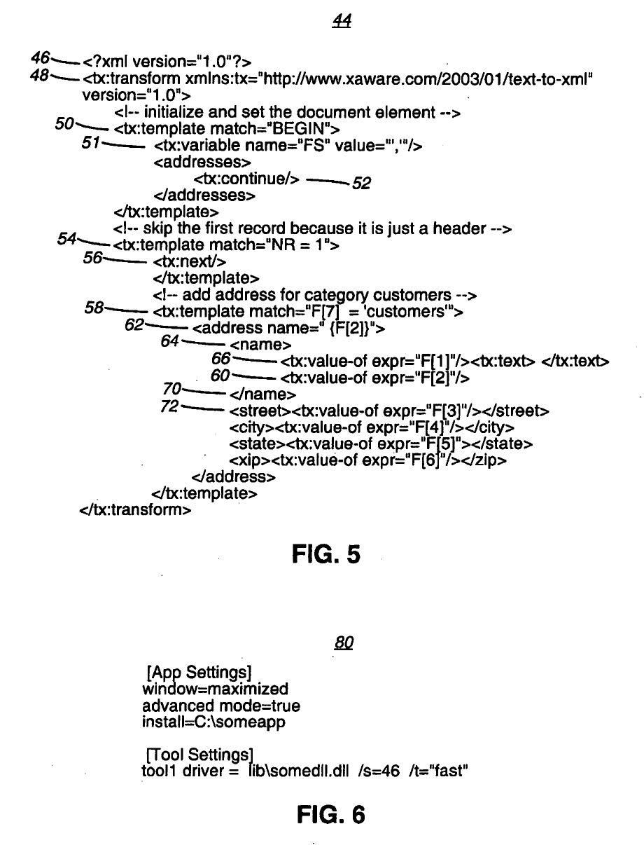

FIG. 3 is an example of text file 40 in accordance with one embodiment of the invention. The text file 40 is an address book in a comma delimited text file. FIG. 4 is the desired output XML 42 version of the address book. FIG. 5 is an example of a transformer document or program 44 that converts the text file 40 into the XML file 42. The first line 46 is just an XML version statement that gets copied to the output 42. The next line 48 defines the output location. Line 50 uses the match=“BEGIN” template rule that establishes the document element of the result tree. The special pattern BEGIN means to fire the rule before reading the first line of the input stream. Line 51 uses the variable FS which is the field separator. FS is defined as a comma by the expression (value=“‘,’”. Line 52 is a command that means that the next template to instantiated will be placed as a child of the addresses element. Thus it is used to establish the hierarchical structure of the output XML. Line 54 shows the use of command template match=“NR=1” that causes the transformer 44 to skip the first record since it is a header that contains the names of the fields. NR is a predefined variable that holds the number of current records. The records are numbered starting at 1. Line 56 causes the transformer to not match any more templates with the current input line. Line 58 tells the computer to select only records that have the category 60 (See FIG. 3) of customer. Note that the category field is field seven (F[7]). Line 62 defines the attribute address name as the second field. Lines 64 through 70 define the name tag as first name, last name. Line 72 defines the street tag as field three. The city, state and zip tags are similarly defined. This simple example shows some of the power of the text to XML transformer and the text to XML language. It shows how only the records matching a desired characteristic are converted to XML. Note that the output 42 does not include Nancy Buxton who is defined as a partner in the input 40 not a customer.

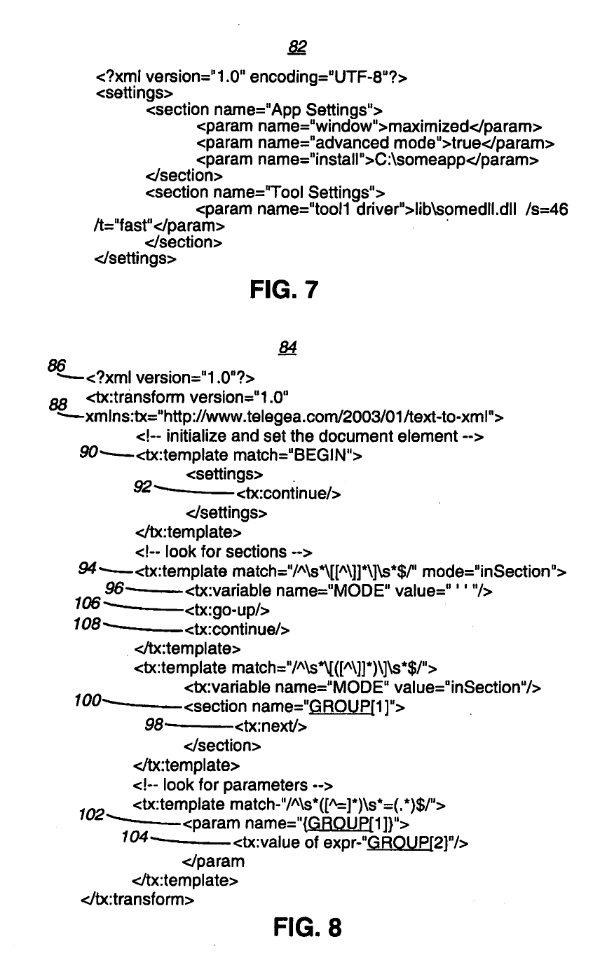

FIG. 6 is an example of a text file 80 in accordance with one embodiment of the invention. This text file is a windows INI format file that is used to define the layout of a window in Microsoft's operating system. FIG. 7 is an example of the desired XML output 82. FIG. 8 is an example of the transformer document 84 that converts the text of FIG. 6 to the XML of FIG. 7. This example is more complicated in that there are two things we are looking for, sections and parameters. The first line 86 is just an XML version statement that gets copies to the output 82. The next line 88 defines the output location. Line 90 uses the match=“BEGIN” template rule that establishes the document element of the result tree. The special pattern BEGIN means to fire the rule before reading the first line of the input stream. Lines 92 & 108 are a command, continue, that means that the next template to instantiated will be placed as a child of the addresses element. Thus it is used to establish the hierarchical structure of the output XML. Line 94 uses the match command to find a regular expression /\hat{ }\s*\[[\hat{ }\]]*\]\s*$/ which says to find lines that begin with zero or more white-space characters followed by a open square bracket then any text except a close square bracket followed by a close square bracket and zero or more white-space characters before the end of the line. This defines the beginning, end and name of the section. Every character matched by the sub expression in parentheses is made available in the built-in array variable GROUP. The elements of GROUP are numbered from left to right starting at 1 for each sub-expression in parentheses. In this case GROUP[1] holds the section name that is in the square brackets at line 100. Line 96 uses the mode attribute that means the template is only matched if the built-in MODE variable has a value that matches the mode attribute value and the match pattern matches. By default MODE has a value of empty string so templates with no mode attribute are checked for matches. The first time a section is seen the third template will be matched (not the second) because MODE is initially empty. This sets the MODE variable to the value “in Section”. We will see why this is done later. This adds a section element under the settings element. The name attribute is set to the name of the section. The tx:next instruction 98 establishes the section element as the current node to add more elements under and causes the next line to be read. Next is used rather than continue because we know there are no more templates we expect to match.

INI file Sections contain zero or more parameters. In our example the first section has 3 parameters. The forth template rule matches parameters. The regular expression /\hat{ }\s*([\hat{ }=]*)\s*=(.*)$/ says to match zero or more white-space characters starting at the beginning of the line followed by any number of characters other than an equal sign followed by zero or more white-space characters then an equal sign and then match any characters up to the end of the line. Capturing groups are used to capture the name of the parameter and its value. The template adds a param element under the current node, which is the section element established by the third template rule. The name attribute value gets the parameter name from GROUP[1] at line 102 and the value of the param element get the parameter value GROUP[2] at line 104. The next two parameters in our example are matched and added to the result tree in the same way.

The tx:go-up element line 106 is used to change the current node context to the parent of the current node. Without this instruction the current node would remain the section element established from the last match of the third template. This new section would be added under the current section rather than just after it (it would become a child rather than a sibling). The go-up instruction is used to go back up the result tree toward the root.

This example shows the use of regular expressions for defining section and parameter elements and shows that two different formats are used in this simple example. Note that it is also possible using these tools to define elements in a string of regular expressions.

The patent cannot show all the components of the text to XML language, however the components are generally broken up into elements and expressions. Examples of elements are

Root Element:

tx:transform
   Top-Level Elements:
tx:decimal-format
tx:input
tx:output
tx:param
tx:template
tx:variable
   Template Instruction Elements:
tx:attribute
tx:call-template
tx:choose
tx:comment
tx:continue
tx:delete
tx:element
tx:exit
tx:for
tx:for-each
tx:if
tx:for
tx:next
tx:otherwise
tx:param
tx:processing-instruction
tx:sort
tx:text
tx:value-of
tx:variable
tx:when
tx:while
tx:with-param

Expressions are used to extract text from the input stream, manipulate it and add it as part of a template so that it becomes part of the output XML result tree. Some expressions are constants, variables, types and conversions, operators, functions calls, and grouping and prededence.

In addition the are predefined variables such as FS field separator, regular expressions are used to match text strings, patterns, functions and associative arrays.

Thus there has been described a text to XML transformer that is easy to use and allows the programmer to inexpensively develop a transformer and can quickly generate the required transformer.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. For instances, other self describing languages other than XML may be used. Accordingly, it is intended to embrace all such alterations, modifications, and variations in the appended claims.

1. A text to XML transformer, comprising:
a transformer program having a plurality of executable statements; and
a processor for executing the transformer program and converting an input text document into an XML document wherein the XML document does not contain every element that was in the input text.

2. The transformer of claim 1, wherein the text document is a structured text document.

3. The transformer of claim 1, wherein the text document is a semi-structured text document.

4. The transformer of claim 1, wherein the input text document has at least two formats.

5. The transformer of claim 4, wherein the text to XML commands include a field separator command that defines a field separator in the text document.

6. The transformer of claim 5, wherein the field separator is a comma.

7. The transformer of claim 5, wherein the field separator is a regular expression.

8. The transformer of claim 4, wherein the text to XML commands include a match command that requires a field in the input text document to match a character string or a record is skipped.

9. The transformer of claim 4, wherein the text to XML commands include a tree hierarchy command.

10. The transformer of claim 1, wherein the input text document is a streaming text.

11. The transformer of claim 1, wherein the XML document is a streaming XML.

12. The transformer of claim 1, further including a wizard that has a number of queries that are used to defined the transformer program.

13. The transformer of claim 1, wherein the input text document is from a legacy system and an output is to an XML system.

14. A process for converting text to XML, comprising the steps of:
a) defining a transformer program having a plurality of executable statements, wherein one of the plurality of executable statements contains a command that matches a regular expression and takes an action;
b) receiving a text stream;
c) executing the transformer program to convert the text stream into an XML stream.

15. The process of claim 14, wherein the step (a) further includes the step of:
a1) selecting a text to XML wizard.

16. The process of claim 14, wherein step (a) further includes the steps of:
a1) selecting a field separator command that defines a field separator in the text stream.

17. The process of claim 16, wherein step (a1) further includes the steps of:
i) defining the field separator as a regular expression.

18. The process of claim 14, wherein step (b) further includes the steps of:
b1) receiving the text stream having two or more formats.

19. A text to XML transformer, comprising:
a wizard for creating a transformer document;
the transformer document having a plurality of statements formed by a text to XML computer language; and
a processor for executing the transformer document and converting an input text document into an XML document.

20. The transformer of claim 19, wherein the text to XML computer language includes a section command to define a section.

21. The transformer of claim 21, wherein the section command uses a regular expression match to define the section.
